(19) United States
(12) Patent Application Publication
(10) Pub. No.: US 2009/0240532 A1
(43) Pub. Date: Sep. 24, 2009

(54) SYSTEM AND METHOD OF MANAGING AN INSURANCE SCHEME

(76) Inventors: Adrian Gore, Houghton Estate (ZA); Herschel Philip Mayers, Johannesburg (ZA); Kenneth Steven Rabson, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/303,391

(22) PCT Filed: May 23, 2007
(86) PCT No.: PCT/IB07/51946

§ 371 Date: Jun. 9, 2009

(30) Foreign Application Priority Data
Jun. 6, 2006 (ZA) 2006/04688

(51) Int. Cl. G06Q 40/00

(52) U.S. Cl. 705/4

(57) ABSTRACT

A method of managing an insurance scheme includes defining a plurality of diseases which are covered by the insurance scheme so that if an insured life contracts one of these diseases they will be paid an amount of funds from the insurer or the insurer will pay or partially pay for treatment of the disease. A request is received from an insured life who has contracted one of the defined diseases. The insured life is provided with a choice of receiving treatment in the country in which they reside or receiving treatment in another country. A selected country is received from the insured life and an amount of funds is paid from the insurer to the insured life wherein the amount of funds is at least partially determined by the selected country.

### BACKGROUND OF THE INVENTION

The present application relates to a system and method of managing an insurance scheme.

The present invention may be implemented by a traditional life insurance plan operator for its members or may be implemented by another party.

Conventionally, insurance policies such as life insurance policies operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

Health insurance policies operate where the provider of the medical scheme undertakes liability in return for a premium or contribution and provides to members who pay such premiums or make such contributions, relevant health services and or assistance in defraying expenses incurred in connection with rendering such relevant health services.

In either case, an insured life that contracts a disease or dread disease, for example, that needs to be treated will have their costs reimbursed but only from a facility in the country within which the insured life resides.

However, in some instances, the best treatment for the disease or dread disease may not be found in the country within which the insured life resides. This treatment will then be inaccessible to the insured life.

A system and method of addressing this is therefore required.

### SUMMARY OF THE INVENTION

According to one example embodiment, a method of managing an insurance scheme, the method including:
defining a plurality of diseases which are covered by the insurance scheme so that if an insured life contracts one of these diseases they will be paid an amount of funds from the insurer or the insurer will pay or partially pay for treatment of the disease;
receiving a request from an insured life who has contracted one of the defined diseases;
providing the insured life with a choice of receiving treatment in the country in which they reside or receiving treatment in another country;
receiving a selected country from the insured life; and
paying an amount of funds from the insurer to the insured life wherein the amount of funds is at least partially determined by the selected country.

The plurality of diseases is typically a plurality of severe illness diseases.

According to another example embodiment there is provided an electronic system for managing an insurance scheme, the system including:
a rules module to define a plurality of diseases which are covered by the insurance scheme so that if an insured life contracts one of these diseases they will be paid an amount of funds from the insurer;
a request module to receive a request from. an insured life who has contracted one of the defined diseases;
a treatment module to provide the insured life with a choice of receiving treatment in the country in which they reside or receiving treatment in another country and to receive a selected country from the insured life; and
a payment module to pay an amount of funds from the insurer to the insured life wherein the amount of funds is at least partially determined by the selected country.

A machine-readable medium embodying instructions which, when executed by a machine, cause the machine to perform a method including:
defining a plurality of diseases which are covered by the insurance scheme so that if an insured life contracts one of these diseases they will be paid an amount of funds from the insurer;
receiving a request from an insured life who has contracted one of the defined diseases;
providing the insured life with a choice of receiving treatment in the country in which they reside or receiving treatment in another country;
receiving a selected country from the insured life; and
paying an amount of funds from the insurer to the insured life wherein the amount of funds is at least partially determined by the selected country.

### BRIEF DESCRIPTION OF THE DRAWINGS

FIG. 1 is a flow chart illustrating the methodology of an example embodiment; and

FIG. 2 is a block diagram illustrating an example system to implement the methodologies described herein.

### DESCRIPTION OF EMBODIMENTS

The systems and methodology described herein relate to a system and method of managing an insurance scheme such as a life insurance scheme or a health insurance scheme.

Conventional life insurance schemes operate on the basis that an insured person, referred to as the insured life, pays premiums on a regular basis to the life insurer, specifying a sum assured which is an amount to be paid out on the occurrence of an insured event. For example, on the death of the insured life, a predetermined death benefit is paid to the nominated beneficiaries of the insured life. If the insured life is disabled or suffers a dread disease, a different, lesser amount is paid out.

Health insurance policies operate where the provider of the medical scheme undertakes liability in return for a premium or contribution and provides to members who pay such premiums, or make such contributions, relevant health services and or assistance in defraying expenses incurred in connection with rendering such relevant health services.

The method and system will be described with reference to these kinds of schemes but it will be appreciated that the method and system could equally be applied to other types of insurance schemes.

It will also be appreciated that the system and methodology may be implemented by any relevant person or organization. For example, the system and methodology may be operated by the organization which operates the life insurance scheme or may be implemented by another associated organization.

It will be appreciated that with the rapid advance of medical technology as well as established recognition of world centers of excellence for specific diseases, the best medical treatment for an illness may not be in the country in which the insured life is insured.

The methodology and system below address this.

For purposes of illustration, the system and methodology will be described herein as being operated by the managers of a life insurance scheme.

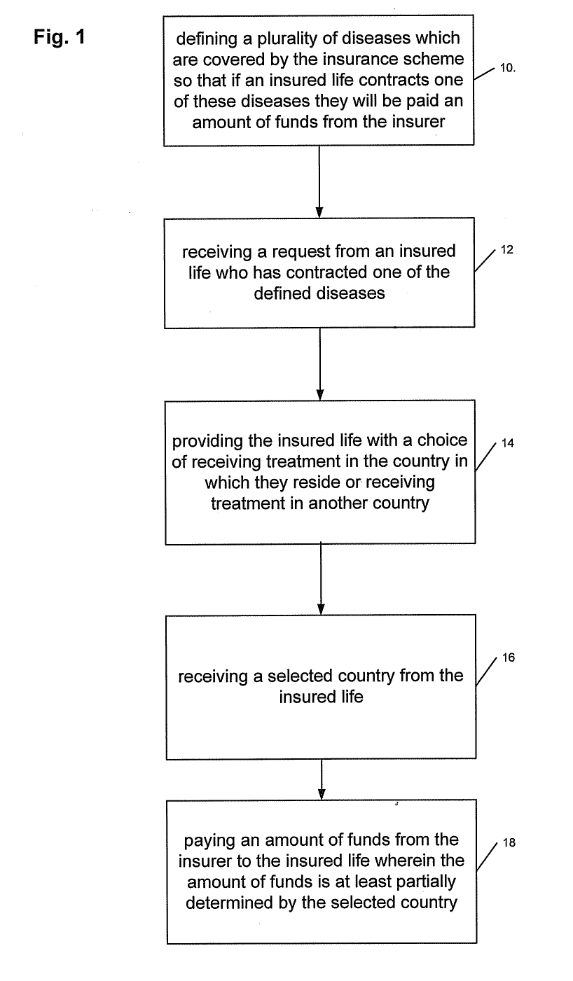

Referring to FIG. 1, a plurality of diseases are defined which are covered by the insurance scheme so that if an insured life contracts one of these diseases they will be paid an amount of funds from the insurer (block 10). Alternatively, the insurer will pay or partially pay for treatment of the disease.

A request from an insured life is received who has contracted one of the defined diseases (block 12).

The insured life is provided with a choice of receiving treatment in the country in which they reside or receiving treatment in another country (block 14).

A selected country is received from the insured life (block 16) and an amount of funds from the insurer to the insured life wherein the amount of funds is at least partially determined by the selected country (block 18).

For example, if the insured life elects to have all treatment performed in their country of residence, for example South Africa, they will receive the normal payout under the Severe Illness Benefit of the insurer. This is payable as a lump sum based on the severity of the illness.

If the insured life elects to have all treatment performed overseas they will receive a different lump sum.

In one example this equals 80% of what they would have received under the first option, less the amount that would be have been paid by a health insurer, plus an amount equal to the actual cost of the treatment at the overseas facility less the amount that would be have been paid by a health insurer had the treatment been done in South Africa (in Rand terms).

In addition, members of a health insurance plan will still receive the amount that would have been paid had the treatment been done in South Africa.

The method is best illustrated using an example case study.

Assume an insured person has a R1,000,000 severe illness benefit with a life insurer and the insured person requires a kidney transplant. They elect for it to be performed in the USA rather than in their home county of South Africa.

The following steps are applied. The cost of the kidney transplant in the USA is approximately R710 000, including pre-and post-transplant costs.

The cost of a kidney transplant in South Africa is approximately R200,000 including pre and post transplant costs which means that the insured person still has a shortfall of R510,000.

The example method provides additional funding as follows, a kidney transplant is a Severity A condition and therefore qualifies for a 100% payment under the severe illness benefit. As the client has a R1,000,000 severe illness benefit, the Life Insurer will pay R1.31m, calculated as follows:
80% of R1,000,000 PLUS
R710 000 (actual cost of treatment) less R200 000 (amount paid by health insurer)

As the health insurer will in any event typically pay the amount of health insurance they normally pay in these kind of situations (R200,000), the total payment from both life and health insurers amounts to a total of R1,510,000.

In addition, the life insurer may arrange discounted costs for the insured life through a network of health providers in the country of choice. This has been calculated into the above as the discounted cost of the procedure is R710,000 and the insured life has more than adequate cover to receive treatment in the USA.

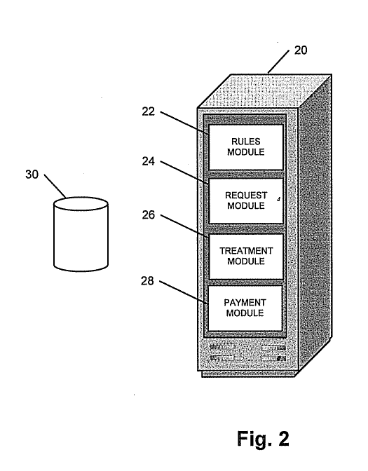

FIG. 2 illustrates an exemplary system for implementing the above methodologies.

A server 20 includes a number of modules to implement the methodologies described above.

A rules module 22 defines a plurality of diseases which are covered by the insurance scheme so that if an insured life contracts one of these diseases they will be paid an amount of funds from the insurer.

A request module 24 receives a request from an insured life who has contracted one of the defined diseases.

A treatment module 26 provides the insured life with a choice of receiving treatment in the country in which they reside or receiving treatment in another country and to receive a selected country from the insured life.

A payment module 28 pays an amount of funds from the insurer to the insured life wherein the amount of funds is at least partially determined by the selected country.

The system may include a database 30 for storing information to allow the methodologies to be implemented.

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

1. A method of managing an insurance scheme, the method including:
defining a plurality of diseases which are covered by the insurance scheme so that if an insured life contracts one of these diseases they will be paid an amount of funds from the insurer or the insurer will pay or partially pay for treatment of the disease;
receiving a request from an insured life who has contracted one of the defined diseases;
providing the insured life with a choice of receiving treatment in the country in which they reside or receiving treatment in another country;
receiving a selected country from the insured life; and
paying an amount of funds from the insurer to the insured life wherein the amount of funds is at least partially determined by the selected country.

2. A method according to claim 1 wherein the plurality of diseases is typically a plurality of severe illness diseases.

3. An electronic system for managing an insurance scheme, the system including:
a rules module to define a plurality of diseases which are covered by the insurance scheme so that if an insured life contracts one of these diseases they will be paid an amount of funds from the insurer or the insurer will pay or partially pay for treatment of the disease;
a request module to receive a request from an insured life who has contracted one of the defined diseases;
a treatment module to provide the insured life with a choice of receiving treatment in the country in which they reside or receiving treatment in another country and to. receive a selected country from the insured life; and
a payment module to pay an amount of funds from the insurer to the insured life wherein the amount of funds is at least partially determined by the selected country.

4. A machine-readable medium embodying instructions which, when executed by a machine, cause the machine to perform a method including:
defining a plurality of diseases which are covered by the insurance scheme so that if an insured life contracts one of these diseases they will be paid an amount of funds from the insurer or the insurer will pay or partially pay for treatment of the disease;
receiving a request from an insured life who has contracted one of the defined diseases;
providing the insured life with a choice of receiving treatment in the country in which they reside or receiving treatment in another country;
receiving a selected country from the insured life; and
paying an amount of funds from the insurer to the insured life wherein the amount of funds is at least partially determined by the selected country.
